(19) United States
(12) Patent Application Publication
(10) Pub. No.: US 2022/0181909 A1
(43) Pub. Date: Jun. 9, 2022

(54) RADIO FREQUENCY-TO-DIRECT CURRENT RECTIFIER AND ENERGY HARVESTING DEVICE INCLUDING THE SAME

(71) Applicant: LX SEMICON CO., LTD., Daejeon (KR)

(72) Inventors: Jong Suk LEE, Daejeon (KR); Young Bok KIM, Daejeon (KR)

(21) Appl. No.: 17/540,378

(22) Filed: Dec. 2, 2021

(30) Foreign Application Priority Data
Dec. 3, 2020 (KR) 10-2020-0167423

(51) Int. Cl. H02J 50/00; H02J 50/20; H02M 7/217

(52) U.S. Cl. CPC H02J 50/001; H02M 7/217; H02J 50/20

(57) ABSTRACT

There is disclosed a radio frequency-to-direct current (RF-DC) rectifier circuit configured to rectify an antenna output voltage converted from RF energy, wherein the RF-DC rectifier circuit rectifies the antenna output voltage using a first diode, which is an N-type metal-oxide-semiconductor (NMOS) transistor, a second diode, which is a P-type metal-oxide-semiconductor (PMOS) transistor, and capacitors to output an energy harvesting current.

### CROSS-REFERENCE TO RELATED APPLICATIONS

This application claims the benefit of the Korean Patent Applications No. 10-2020-0167423 filed on Dec. 3, 2020 which is hereby incorporated by reference as if fully set forth herein.

### FIELD OF THE INVENTION

The present specification relates to a radio frequency-to-direct current (RF-DC) rectifier and an energy harvesting device including the same.

### BACKGROUND

Energy harvesting devices receive energy from an external energy source such as, for example, light, heat, radio waves, pressure, and the like, convert the received energy into electrical energy, and collect the converted electrical energy to charge a battery. The energy harvesting devices may include a circuit for converting energy received from the external energy source into electrical energy and effectively charging the converted electrical energy into the battery.

### SUMMARY

The present disclosure is directed to providing a radio frequency-to-direct current (RF-DC) rectifier capable of outputting a high and stable voltage, and an energy harvesting device including the same.

According to an aspect of the present disclosure, there is provided an RF-DC rectifier circuit configured to rectify an antenna output voltage converted from RF energy, wherein the RF-DC rectifier circuit rectifies the antenna output voltage using a first diode, which is an N-type metal-oxide-semiconductor (NMOS) transistor, a second diode, which is a P-type metal-oxide-semiconductor (PMOS) transistor, and capacitors to output an energy harvesting current.

According to another aspect of the present disclosure, there is provided an energy harvesting device including a radio frequency (RF) energy converter configured to convert ambient RF energy to output an energy harvesting current, and an energy storage configured to receive and store the energy harvesting current and output a first auxiliary voltage generated due to the stored power, wherein the RF energy converter includes an antenna part including an antenna configured to collect the ambient RF energy to output an antenna output voltage, and an RF-to-direct current (RF-DC) rectifier circuit part configured to rectify the antenna output voltage using a first diode, which is an N-type metal-oxide-semiconductor (NMOS) transistor, a second diode, which is a P-type metal-oxide-semiconductor (PMOS) transistor, and capacitors to output the energy harvesting current.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a diagram illustrating a configuration of an energy harvesting device according to one embodiment of the present disclosure;

FIG. 2 is a view illustrating a structure of an antenna part of a radio frequency (RF) energy converter according to one embodiment of the present disclosure;

FIG. 3 is a diagram illustrating a circuit structure of an RF-to-direct current (RF-DC) rectifier circuit part according to one embodiment of the present disclosure;

FIG. 4 is a graph illustrating a voltage output from the RF-DC rectifier circuit part according to one embodiment of the present disclosure; and

FIG. 5 is a flowchart illustrating an energy harvesting process according to one embodiment of the present disclosure.

### DETAILED DESCRIPTION

In the specification, it should be noted that like reference numerals already used to denote like elements in other drawings are used for elements wherever possible. In the following description, when a function and a configuration known to those skilled in the art are irrelevant to the essential configuration of the present disclosure, their detailed descriptions will be omitted. The terms described in the specification should be understood as follows.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Further, the present disclosure is only defined by scopes of claims.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted.

In a case where ‘comprise’, ‘have’, and ‘include’ described in the present specification are used, another part may be added unless ‘only˜’ is used. The terms of a singular form may include plural forms unless referred to the contrary.

In construing an element, the element is construed as including an error range although there is no explicit description.

In describing a time relationship, for example, when the temporal order is described as ‘after˜’, ‘subsequent˜’, ‘next˜’, and ‘before˜’, a case which is not continuous may be included unless ‘just’ or ‘direct’ is used.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item.

Features of various embodiments of the present disclosure may be partially or overall coupled to or combined with each other, and may be variously inter-operated with each other and driven technically as those skilled in the art can sufficiently understand. The embodiments of the present disclosure may be carried out independently from each other, or may be carried out together in co-dependent relationship.

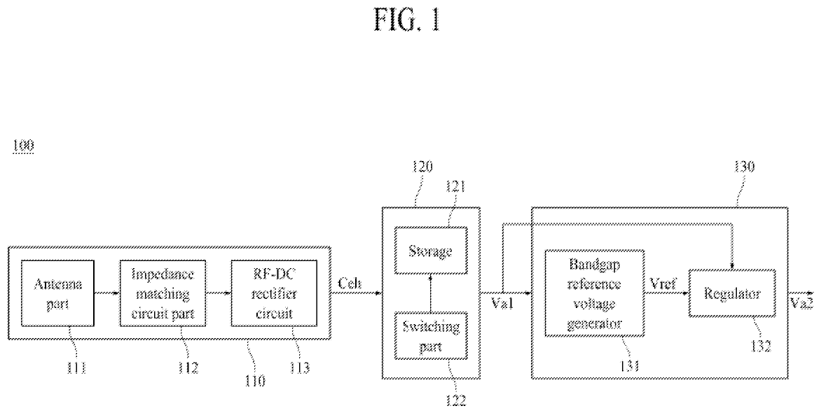

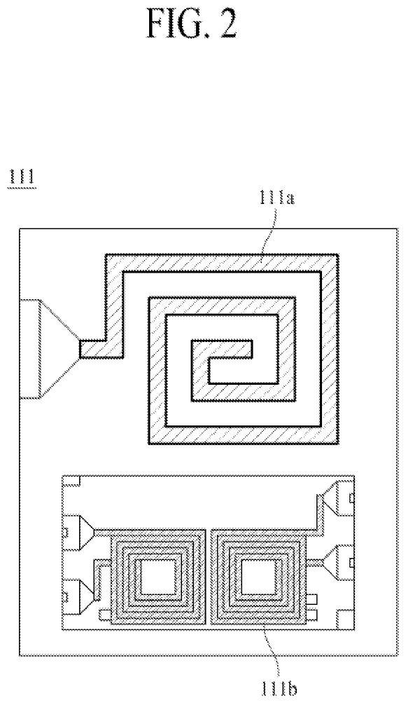

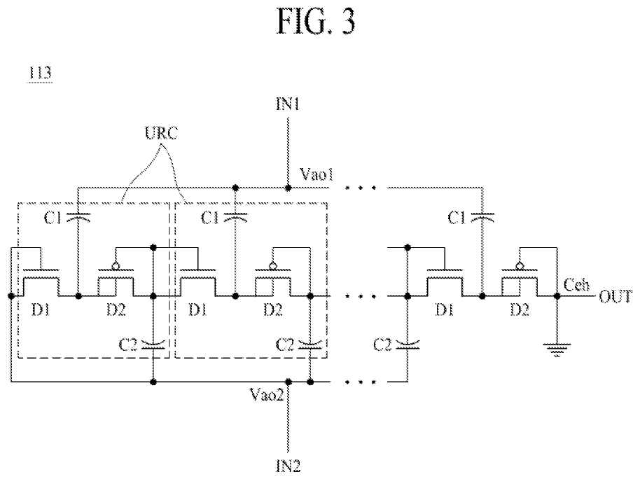

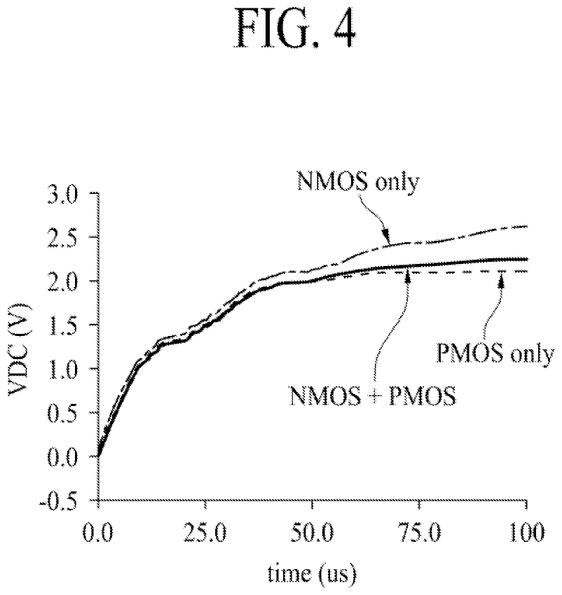

Hereinafter, an energy harvesting device according to the present disclosure will be described in detail with reference to FIGS. 1 to 4. FIG. 1 is a diagram illustrating a configuration of an energy harvesting device according to one embodiment of the present disclosure, FIG. 2 is a view illustrating a structure of an antenna part of a radio frequency (RF) energy converter according to one embodiment of the present disclosure, and FIG. 3 is a diagram illustrating a circuit structure of an RF-to-direct current (RF-DC) rectifier circuit part according to one embodiment of the present disclosure. FIG. 4 is a graph illustrating a voltage output from the RF-DC rectifier circuit part according to one embodiment of the present disclosure.

An energy harvesting device 100 converts RF energy into electrical energy and outputs the electrical energy. As shown in FIG. 1, the energy harvesting device 100 according to one embodiment of the present disclosure includes an RF energy converter 110, an energy storage 120, and a voltage stabilizer 130.

The RF energy converter 110 collects ambient RF energy and converts the collected RF energy into electrical energy. Specifically, the RF energy converter 110 collects ambient RF energy, and converts the collected RF energy to output an energy harvesting current Ceh to the energy storage 120. At this point, the energy harvesting current Ceh output from the RF energy converter 110 may include noise because it has not passed through a separate rectifier circuit.

As shown in FIG. 1, the RF energy converter 110 according to one embodiment of the present disclosure includes an antenna part 111, an impedance matching circuit part 112, and an RF-DC rectifier circuit part 113.

The antenna part 111 collects RF energy generated due to external electromagnetic radiation in the ambient environment and generates an antenna output voltage corresponding to the collected RF energy. At this point, the antenna output voltage is an alternating current (AC) voltage.

The antenna part 111 may include a plurality of antennas for collecting RF energy of different frequencies to increase the total amount of RF energy collected by the antenna part 111. The antenna part 111 may include a plurality of antennas each for collecting RF energy corresponding to each frequency band. Specifically, as shown in FIG. 2, the antenna part 111 may include a first antenna 111a and a second antenna 111b for collecting RF energy of different frequency bands. Each of the antennas may have a smaller area as a receiving frequency band increases. For example, the antenna part 111 may include the first antenna 111a configured to collect RF energy of a frequency band of 1.1 GHz and a second antenna 111b configured to collect RF energy of a frequency band of 1.8 GHz, and the first antenna 111a may have a larger area than the second antenna 111b.

The impedance matching circuit part 112 allows the impedance of the antenna part 111 to be matched to that of the RF-DC rectifier circuit part 113, thereby improving the reception efficiency of the RF energy collected by the antenna part 111.

The RF-DC rectifier circuit part 113 rectifies an impedance-matched antenna output voltage to output the energy harvesting current Ceh to the energy storage 120. Specifically, the RF-DC rectifier circuit part 113 receives and rectifies a first antenna output voltage Vao1, which is the antenna output voltage output from the antenna part 111, and a second antenna output voltage Vao2, which is an inverted voltage of the antenna output voltage, to output the energy harvesting current Ceh. For example, as shown in FIG. 3, the RF-DC rectifier circuit part 113 receives the first antenna output voltage Vao1 through a first input terminal IN1 and receives the second antenna output voltage Vao2 through a second input terminal IN2, and rectifies the received first and second antenna output voltage Vao1 and Vao2 to output the energy harvesting current Ceh.

The RF-DC rectifier circuit part 113 according to one embodiment of the present disclosure receives the first antenna output voltage Vao1, which is the antenna output voltage, and the second antenna output voltage Vao2, which is a voltage inverted from the antenna output voltage, and thus does not include a separate oscillator including a clock.

The RF-DC rectifier circuit part 113 according to one embodiment of the present disclosure rectifies the antenna output voltage using a plurality of diodes D1 and D2 and a plurality of capacitors C1 and C2. Specifically, the RF-DC rectifier circuit part 113 includes one or more unit rectifier circuits URC each including a first diode D1, which is an N-type metal-oxide-semiconductor (NMOS) transistor, a second diode D2, which is a P-type metal-oxide-semiconductor (PMOS) transistor, a first capacitor C1 connected to an output terminal of the first diode D1, and a second capacitor C2 connected to an output terminal of the second diode D2. Accordingly, the RF-DC rectifier circuit part 113 may be configured by linearly connecting the one or more unit rectifier circuits URC. Accordingly, the RF-DC rectifier circuit part 113 rectifies the first antenna output voltage Vao1 and the second antenna output voltage Vao2 through the one or more unit rectifier circuits URC to output the energy harvesting current Ceh.

The RF-DC rectifier circuit part 113 includes the first input terminal IN1, through which the first antenna output voltage Vao1 that is the antenna output voltage is received, the second input terminal IN2, through which the second antenna output voltage Vao2 that is an inverted voltage of the antenna output voltage is received, the above-described one or more unit rectifier circuits URC, and an output terminal OUT through which the energy harvesting current Ceh which is rectified by the one or more unit rectifier circuits URC is output. At this point, as shown in FIG. 3, the first input terminal IN1 is connected to the output terminal of the first diode D1 and an input terminal of the second diode D2 through the first capacitor C1, and the second input terminal IN2 is connected to an input terminal and a control terminal of the first diode D1 and connected to the output terminal and a control terminal of the second diode D2 through the second capacitor C2.

The RF-DC rectifier circuit part 113 according to one embodiment of the present disclosure includes the first diode D1, which is an NMOS transistor having a high threshold voltage and low turn-on resistance, and the second diode D2, which is a PMOS transistor having a low threshold voltage and high turn-on resistance. Accordingly, as shown in FIG. 4, the RF-DC rectifier circuit part 113 including the first diode D1, which is an NMOS transistor, and the second diode D2, which is a PMOS transistor, outputs a more stable voltage than a rectifier circuit configured with only the NMOS transistor, and outputs a higher voltage than a rectifier circuit configured with only the PMOS transistor.

The energy storage 120 receives the energy harvesting current Ceh and stores power, and when a first auxiliary voltage Va1, which is a voltage generated due to the power stored in the energy storage 120, is greater than or equal to a usable voltage, the first auxiliary voltage Va1 is output to the voltage stabilizer 130.

As the energy harvesting current Ceh is input to the energy storage 120, the amount of power stored in the energy storage 120 increases. Accordingly, when the first auxiliary voltage Va1 generated due to the stored power increases and the first auxiliary voltage Va1 is greater than or equal to the usable voltage, the energy storage 120 outputs the first auxiliary voltage Va1.

According to one embodiment of the present disclosure, since the RF energy converter 110 includes the RF-DC rectifier circuit part 113, the RF energy converter 110 may output the rectified energy harvesting current Ceh, and accordingly, the energy storage 120 may be directly connected to the RF energy converter 110. That is, since the energy storage 120 receives the energy harvesting current Ceh that is output from the RF energy converter 110 and is not rectified, the first auxiliary voltage Va1 output from the energy storage 120 may include noise, and thus, the noise of the first auxiliary voltage Va1 may be removed through the voltage stabilizer 130 to output a stable second auxiliary voltage Va, which will be described below.

The energy storage 120 includes a storage 121 configured to receive the energy harvesting current Ceh and store power and a switching part 122 configured to output the first auxiliary voltage Va1 to the voltage stabilizer 130 when the first auxiliary voltage Va1, which is a voltage generated due to the stored power, is greater than or equal to a usable voltage.

The storage 121 receives the energy harvesting current Ceh from the RF energy converter 110 and stores power.

The switching part 122 controls the storage 121 to output the first auxiliary voltage Va1 to the voltage stabilizer 130 when the first auxiliary voltage Va1 generated due to the power stored in the storage 121 is greater than or equal to the usable voltage.

The voltage stabilizer 130 rectifies the first auxiliary voltage Va1 output from the energy storage 120 to output the second auxiliary voltage Va2. In detail, since the energy storage 120 receives the energy harvesting current Ceh, which is not rectified, the first auxiliary voltage Va1 output from the energy storage 120 may include noise. Accordingly, the voltage stabilizer 130 removes the noise from the first auxiliary voltage Va1 output from the energy storage 120 and outputs the second auxiliary voltage Va2 having a stable level.

Referring to FIG. 1 again, the voltage stabilizer 130 includes a bandgap reference voltage generator 131 and a regulator 132.

The bandgap reference voltage generator 131 generates a bandgap reference voltage Vref that maintains a constant level even when the temperature changes, and provides the bandgap reference voltage Vref to the regulator 132, which will be described below.

The regulator 132 outputs the second auxiliary voltage Va2 corresponding to the first auxiliary voltage Va1 using the reference voltage Vref generated from the bandgap reference voltage generator 131. Accordingly, the voltage stabilizer 130 according to one embodiment of the present disclosure may output a more stable second auxiliary voltage Va2 from which noise is removed.

In the voltage stabilizer 130 according to one embodiment of the present disclosure, a DC-DC converter including an inductor is replaced with the bandgap reference voltage generator 131 and the regulator 132 so that power loss caused by the inductor of the DC-DC converter may be prevented, and complex analog circuits are replaced with the bandgap reference voltage generator 131 and the regulator 132 so that a circuit area of the voltage stabilizer 130 may be reduced.

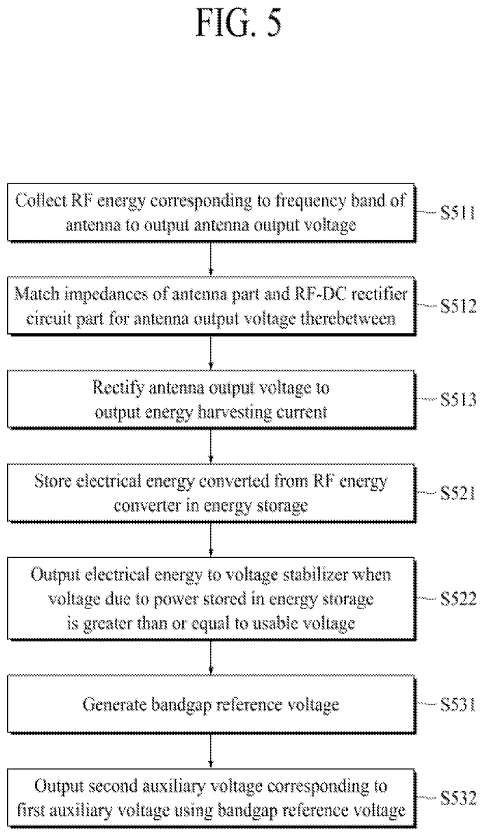

Hereinafter, an energy harvesting process according to the present disclosure will be described in detail with reference to FIG. 5. FIG. 5 is a flowchart illustrating an energy harvesting process according to one embodiment of the present disclosure.

Operations S511 to S513 are performed by the RF energy converter 110, operations S521 and S522 are performed by the energy storage 120, and operations S531 and S532 are performed by the voltage stabilizer 130.

First, the energy harvesting device 100 converts RF energy corresponding to a frequency band of the antenna to output an antenna output voltage (S511). The energy harvesting device 100 may include a plurality of antennas for collecting RF energy of different frequencies to increase the total amount of RF energy received by the energy harvesting device 100.

Thereafter, the energy harvesting device 100 may match impedances of the antenna part 111 and the RF-DC rectifier circuit part 113 for the antenna output voltage therebetween in order to improve the reception efficiency of the RF energy (S512).

Thereafter, as described above, the energy harvesting device 100 rectifies the antenna output voltage to generate an energy harvesting current Ceh (S513). According to one embodiment of the present disclosure, the antenna output voltage is rectified by the RF-DC rectifier circuit part 113 including the first diode D1, which is an NMOS transistor having a high threshold voltage and low turn-on resistance, and the second diode D2, which is a PMOS transistor having a low threshold voltage and high turn-on resistance, to be converted into the energy harvesting current Ceh. Accordingly, the RF-DC rectifier circuit part 113 including the first diode D1, which is an NMOS transistor, and the second diode D2, which is a PMOS transistor, outputs a more stable voltage than a rectifier circuit configured with only the NMOS transistor, and outputs a higher voltage than a rectifier circuit configured with only the PMOS transistor.

According to one embodiment of the present disclosure, since the RF energy converter 110 includes the RF-DC rectifier circuit part 113, the RF energy converter 110 may output the rectified energy harvesting current Ceh, and accordingly, the energy storage 120 may be directly connected to the RF energy converter 110. That is, since the energy storage 120 receives the energy harvesting current CEH which is output from the RF energy converter 110 and is not rectified, the energy storage 120 may include noise, and thus a first auxiliary voltage Va1 output from the energy storage 120 may include noise.

Thereafter, the energy harvesting device 100 stores electrical energy converted by the RF energy converter 110 in the energy storage 120 (S521). Specifically, the energy harvesting current Ceh converted by the RF energy converter 110 is input to the energy storage 120, and the energy storage 120 stores power.

The energy harvesting device 100 outputs the stored electrical energy to the voltage stabilizer 130 when a voltage generated due to the energy harvesting current Ceh is greater than or equal to a usable voltage (S522). Specifically, when the energy harvesting current Ceh is input to the energy storage 120 and the first auxiliary voltage Va1 generated due to the stored power is greater than or equal to the usable voltage, the switching part 122 controls the storage 121 to output the first auxiliary voltage Va1 so that the energy harvesting device 100 outputs the first auxiliary voltage Va1.

Thereafter, the energy harvesting device 100 outputs a bandgap reference voltage Vref, which maintains a constant level even when the temperature changes, through the bandgap reference voltage generator 131 of the voltage stabilizer 130 (S531).

Thereafter, the energy harvesting device 100 receives the bandgap reference voltage Vref, which is generated from the bandgap reference voltage generator 131, and the first auxiliary voltage Va1 through the regulator 132 of the voltage stabilizer 130 to output a second auxiliary voltage Va2 corresponding to the first auxiliary voltage Va1 using the reference voltage Vref (S532). Accordingly, the energy harvesting device 100 according to one embodiment of the present disclosure may output a more stable second auxiliary voltage Va2 without noise.

The energy harvesting device 100 according to one embodiment of the present disclosure includes the bandgap reference voltage generator 131 and the regulator 132 rather than a DC-DC converter including an inductor so that power loss caused by the inductor of the DC-DC converter may be prevented, and complex analog circuits are replaced with the bandgap reference voltage generator 131 and the regulator 132, thereby reducing a circuit area of the voltage stabilizer 130.

An RF-DC rectifier and an energy harvesting device including the same according to the present disclosure include an NMOS transistor having a high threshold voltage and low turn-on resistance, and a PMOS transistor having a low threshold voltage and high turn-on resistance, and thus can output a stable and high voltage as compared with an RF-DC rectifier circuit configured with only the NMOS transistor and an RF-DC rectifier circuit configured with only the PMOS transistor.

In addition, in an RF-DC rectifier and an energy harvesting device including the same according to the present disclosure, there is an effect that an RF energy converter configured to convert RF energy into electrical energy can be directly connected to an energy storage by including an RF-DC rectifier circuit part configured to rectify the electrical energy converted from the RF energy.

It will be apparent to those skilled in the art that various changes and modifications may be made without departing from the spirit and scope of the disclosure.

Therefore, it should be understood that the above-described embodiments are not restrictive but illustrative in all aspects. The scope of the present disclosure is defined by the appended claims rather than the detailed description, and it should be construed that all alternations or modifications derived from the meaning and scope of the appended claims and the equivalents thereof fall within the scope of the present disclosure.

### DESCRIPTION OF REFERENCE NUMERALS

100: energy harvesting device
110: RF energy converter
111: antenna part
112: impedance matching circuit part
113: RF-DC rectifier circuit part
120: energy storage
121: storage
122: switching part
130: voltage stabilizer
131: bandgap reference voltage generator
132: regulator

What is claimed is:

1. A radio frequency-to-direct current (RF-DC) rectifier circuit configured to rectify an antenna output voltage converted from RF energy,
wherein the RF-DC rectifier circuit rectifies the antenna output voltage using a first diode, which is an N-type metal-oxide-semiconductor (NMOS) transistor, a second diode, which is a P-type metal-oxide-semiconductor (PMOS) transistor, and two capacitors to output an energy harvesting current.

2. The RF-DC rectifier circuit of claim 1, wherein the RF-DC rectifier circuit is configured by linearly connecting one or more unit rectifier circuits each including the first diode, the second diode, and the two capacitors.

3. The RF-DC rectifier circuit of claim 2, wherein the unit rectifier circuits receive and rectify a first antenna output voltage, which is the antenna output voltage, and a second antenna output voltage, which is an inverted voltage of the antenna output voltage, to output the energy harvesting current.

4. The RF-DC rectifier circuit of claim 1,
wherein the RF-DC rectifier circuit includes:
a first input terminal through which a first antenna output voltage, which is the antenna output voltage, is received;
a second input terminal through which a second antenna output voltage, which is an inverted voltage of the antenna output voltage, is received;
one or more unit rectifier circuits configured to receive the first antenna output voltage and the second antenna output voltage, and rectify the first and second antenna output voltages using the first diode, the second diode, a first capacitor, and a second capacitor to output the energy harvesting current; and
an output terminal connected to the one or more unit rectifier circuits and through which the energy harvesting current is output.

5. The RF-DC rectifier circuit of claim 1,
wherein the RF-DC rectifier circuit includes:
a first input terminal through which a first antenna output voltage, which is the antenna output voltage, is received;
a second input terminal through which a second antenna output voltage, which is an inverted voltage of the first antenna output voltage, is received;
one or more unit rectifier circuits configured to receive the first antenna output voltage and the second antenna output voltage, and rectify the first and second antenna output voltages using the first diode, the second diode, a first capacitor, and a second capacitor to output the energy harvesting current; and
an output terminal through which the energy harvesting current output from the unit rectifier circuits is output,
wherein in each of the unit rectifier circuits, the first diode and the second diode are alternately and linearly connected,
the first input terminal is connected to an output terminal of the first diode and an input terminal of the second diode through the first capacitor, and
the second input terminal is connected to an input terminal and a control terminal of the first diode, and is connected to an output terminal and a control terminal of the second diode through the second capacitor.

6. An energy harvesting device comprising:
a radio frequency (RF) energy converter configured to convert ambient RF energy to output an energy harvesting current; and
an energy storage configured to receive and store the energy harvesting current and output a first auxiliary voltage generated due to the stored power,
wherein the RF energy converter includes:
an antenna part configured to collect the ambient RF energy to output an antenna output voltage; and
an RF-to-direct current (RF-DC) rectifier circuit part configured to rectify the antenna output voltage using a first diode, which is an N-type metal-oxide-semiconductor (NMOS) transistor, a second diode, which is a P-type metal-oxide-semiconductor (PMOS) transistor, and two capacitors to output the energy harvesting current.

7. The energy harvesting device of claim 6, wherein the RF-DC rectifier circuit part is configured by linearly connecting one or more unit rectifier circuits each including the first diode, the second diode, and the two capacitors.

8. The energy harvesting device of claim 7, wherein the unit rectifier circuits receive and rectify a first antenna output voltage, which is the antenna output voltage, and a second antenna output voltage, which is an inverted voltage of the antenna output voltage, to output the energy harvesting current.

9. The energy harvesting device of claim 6,
wherein the RF-DC rectifier circuit part includes:
a first input terminal through which a first antenna output voltage, which is the antenna output voltage, is applied;
a second input terminal through which a second antenna output voltage, which is an inverted voltage of the antenna output voltage, is applied;
one or more unit rectifier circuits configured to receive the first antenna output voltage and the second antenna output voltage, and rectify the first and second antenna output voltages using the first diode, the second diode, a first capacitor, and a second capacitor to output the energy harvesting current; and
an output terminal through which the energy harvesting current output from the unit rectifier circuits is output.

10. The energy harvesting device of claim 6,
wherein the RF-DC rectifier circuit part includes:
a first input terminal through which a first antenna output voltage, which is the antenna output voltage, is received;
a second input terminal through which a second antenna output voltage, which is an inverted voltage of the first antenna output voltage, is received;
one or more unit rectifier circuits configured to receive the first antenna output voltage and the second antenna output voltage, and rectify the first and second antenna output voltages using the first diode, the second diode, a first capacitor, and a second capacitor to output the energy harvesting current; and
an output terminal through which the energy harvesting current output from the unit rectifier circuits is output,
wherein in each of the unit rectifier circuits, the first diode and the second diode are alternately and linearly connected,
the first input terminal is connected to an output terminal of the first diode and an input terminal of the second diode through the first capacitor, and
the second input terminal is connected to an input terminal and a control terminal of the first diode, and is connected to an output terminal and a control terminal of the second diode through the second capacitor.

11. The energy harvesting device of claim 6, further comprising a voltage stabilizer configured to generate a reference voltage and output a second auxiliary voltage corresponding to the first auxiliary voltage using the reference voltage.

12. The energy harvesting device of claim 11,
wherein the voltage stabilizer includes:
a bandgap reference voltage generator configured to generate the reference voltage that maintains a constant level in response to temperature changes; and
a regulator configured to receive the first auxiliary voltage and the reference voltage to output a second auxiliary voltage of a constant level corresponding to the first auxiliary voltage using the reference voltage.

13. The energy harvesting device of claim 6, wherein the energy storage is directly connected to the RF energy converter, receives the energy harvesting current, and outputs the first auxiliary voltage when a voltage generated due to the energy harvesting current is greater than or equal to a usable voltage.
